(19) United States
(12) Patent Application Publication
(10) Pub. No.: US 2025/0332457 A1
(43) Pub. Date: Oct. 30, 2025

(54) Wildfire Protection System

(71) Applicants: William Garnett, Portland, OR (US); Mahdy Atwi, Portland, OR (US)

(72) Inventors: William Garnett, Portland, OR (US); Mahdy Atwi, Portland, OR (US)

(21) Appl. No.: 19/190,586

(22) Filed: Apr. 26, 2025

Related U.S. Application Data
(60) Provisional application No. 63/639,241, filed on Apr. 26, 2024.

(51) Int. Cl. A62C 3/02

(52) U.S. Cl. CPC A62C 3/0264

(57) ABSTRACT

A wildfire protection system is provided comprising a plurality of hose sections arranged in an end-to-end manner in a chain, each section about one foot in length. The system also comprises a plurality of misting heads about 2.5 inches in length each, one each of the plurality of heads positioned between ends of adjacent hose sections. Each misting head receives water at an intake end from a first connecting hose section, expels a portion of the water through at least one opening in each head, and releases a remainder of the received water at a discharge end to a second connecting hose section. The chain receives water at one end and a second end is capped in a half circuit structure. Alternatively the chain receives water at both ends in a closed loop structure, the structure at least directed to evenly distributing water pressure in the chain.

### CROSS REFERENCE TO RELATED APPLICATIONS

The present non-provisional patent application is related to U.S. Provisional Patent Application No. 63/639,241 filed Apr. 26, 2024, the contents of which are incorporated herein in their entirety.

### FIELD OF THE DISCLOSURE

The present disclosure is in the field of wildfire suppression. More particularly the present disclosure provides a chain of alternating hose sections and misting heads that spray water under pressure downward to form a misting curtain that protects structures and other assets from wildfires and particularly airborne embers.

### BACKGROUND

A wildfire, forest fire, or a bushfire is an unplanned and uncontrolled fire in an area of combustible vegetation. Depending on the type of vegetation present, a wildfire may be more specifically identified as a bushfire, desert fire, grass fire, hill fire, peat fire, prairie fire, or vegetation fire. Some natural forest ecosystems depend on wildfire. Modern forest management often engages in prescribed burns to mitigate fire risk and promote natural forest cycles. However, controlled burns can turn into wildfires by mistake.

While costs vary wildly from year to year, depending on the severity of each fire season, in the United States, local, state, federal and tribal agencies collectively spend tens of billions of dollars annually to suppress wildfires. In the United States, it was reported that approximately $6 billion was spent between 2004-2008 to suppress wildfires in the country. In California, the U.S. Forest Service spends about $200 million per year to suppress 98% of wildfires and up to $1 billion to suppress the other 2% of fires that escape initial attack and become large.

### BRIEF DESCRIPTION OF THE FIGURES

FIG. 1 is a diagram of a system of wildfire protection according to an embodiment of the present disclosure.

FIG. 2 is a diagram of a system of wildfire protection according to an embodiment of the present disclosure.

FIG. 3 is a diagram of a system of wildfire protection according to an embodiment of the present disclosure.

FIG. 4 is a diagram of a system of wildfire protection according to an embodiment of the present disclosure.

FIG. 5 is a diagram of a system of wildfire protection according to an embodiment of the present disclosure.

### DETAILED DESCRIPTION

Systems and methods described herein support protection from wildfires for structures and other assets by providing a chain of alternating hose sections and misting heads that may be hung horizontally from an eave area or other elevated area of a structure and drop mist in a curtainlike manner. Each misting head receives water under pressure at an intake opening from a hose section. The incoming water enters a chamber inside the misting head.

Much of the water is then passed along and out a discharge opening to the next misting head. But each misting head has at least one small opening facing downward through which water is forced in a stream out of the misting head. The water then strikes a misting platform held by an arm just below the misting head which causes the stream to be dispersed and radiate outward and downward as mist.

This action taking place along a succession of misting heads in the chain effectively creates a curtain of mist as the mist falls downward from the chain. Such a curtain of mist can block airborne embers and other debris from making contact with the structure and from being sucked into openings, for example a window or vent of the house.

The chain may receive water in many embodiments from a standard household outdoor water faucet. The pressure of water from the faucet into the chain in most instances is adequate to force water through the chain and out the holes or openings in the misting heads without overloading the chain and potentially breaking it. No pump or similar devices are needed in many embodiments. Each misting heads may be about two and one half (2.5) inches in length and each hose section may be about one foot in length.

The system may be configured in various manners. Two basic structures are provided with water entering the chain at one end with the other end capped or alternatively with water entering the chain at both ends such that water is effectively entering and passing through the chain in opposite directions and toward each other. With the first structure, the water enters the one end of the chain at a pressure such that nearly all of the water is expelled through the small openings in the misting heads along the length of the chain. Pressure does not build at the far end of the chain near the cap or elsewhere such that the chain is overloaded and may break.

Similarly with the second structure, the pressure of the water entering the chain from each of the two ends and toward each other is such that the chain can adequately withstand the pressure and not overload. With the second structure, each of the two ends may connect to its own water source, for example separate outdoor faucets. Alternatively, under the second structure, both ends may draw water from the same source by using a “Y”-shaped splitter fitting on the faucet such that water from the one faucet is fed to both ends of the chain.

In an example, a homeowner during the time of year that is typically fire season may hang or suspend the chain in a horizontal manner from an eave or gutter area of his/her house. The homeowner connects one end of the chain to an exterior water faucet that is typically used for connecting garden hoses. In embodiments there may be some regulating, connecting, extension hardware in between the faucet and the beginning of the chain which is typically the first hose section of the chain.

The homeowner might not normally turn the water on until needed such as when a wildfire is in the area. In the alternative embodiment discussed above, the homeowner would connect both ends of the chain to separate water sources or the same water source using the splitter fitting as described.

When an evacuation order is issued by the authorities, the homeowner turns the water faucet or faucets on. The chain fills with water and immediately begins expelling water through the downward facing small holes in the misting heads. As noted, the downward stream under pressure contacts the misting platform below the misting heads and bounces off them, radiating outward and converting the stream into a mist. This action occurs simultaneously at a succession of misting heads of the chain.

The homeowner can leave his/her home and travel to the evacuation site for however many hours or days are mandated by the authorities. The homeowner may be confident during this evacuation period that his/her home is more likely safe as the curtain of mist continues to fall from the chain of misting heads and keeps exterior surfaces of the house damp or wet. As periods of wildfire tend to be windy, the mist falling from the chain may be blown about and also spread water to areas of roofs and dormers as well as ground areas of the residence, further limiting risk.

When the wildfire risk is mitigated because the previously dangerous wildfire is extinguished by fire authorities, is affected by weather, or is rendered under control precipitation or shifts because of wind direction changes, the authorities may lift the evacuation order, and the homeowner may return to his/her home. The homeowner or some other party, such as fire authorities, may then turn off the system 100 such that water is no longer entering the system 100. In an embodiment, the water may be turned off by the homeowner or other party even when the wildfire is ongoing if, for example, the authorities determine that water pressure needed by firefighters is inadequate and private systems such as the system 100 must be shut down such that the firefighters can battle the blaze.

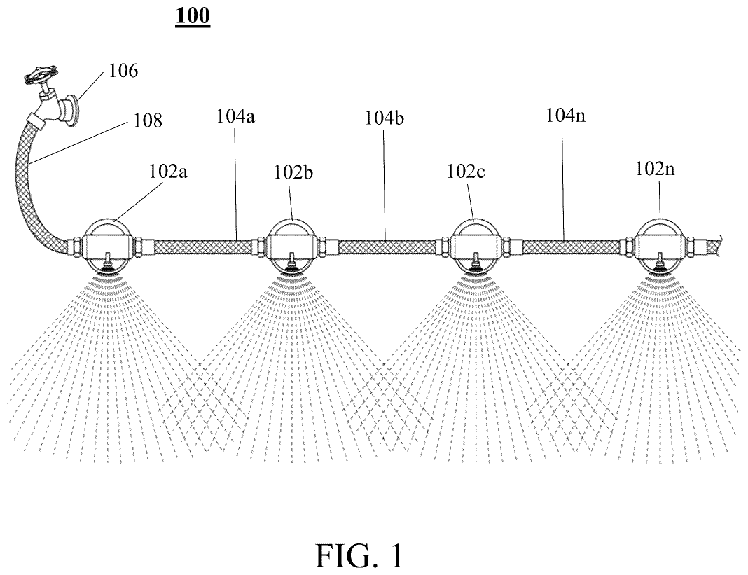

Turning to the figures, FIG. 1 is a diagram of a system of a wildfire protection system according to an embodiment of the present disclosure. A system 100 is provided and depicted in FIG. 1 comprising misting heads 102a-n and hose sections 104a-n which may be referred to for brevity hereinafter as heads 102a-n and sections 104a-n, respectively. As discussed above and depicted in FIG. 1, water in a mist form falls from the system 100 in a curtain-like fashion.

System 100 also comprises a water source 106 and connection hardware 108. The term “chain” as used herein refers to a plurality of 102a-n and sections 104a-n arranged in an alternating manner as shown in FIG. 1. For discussion purposes, the water source 106 and connection hardware 108 are not part of the “chain” and are separate components

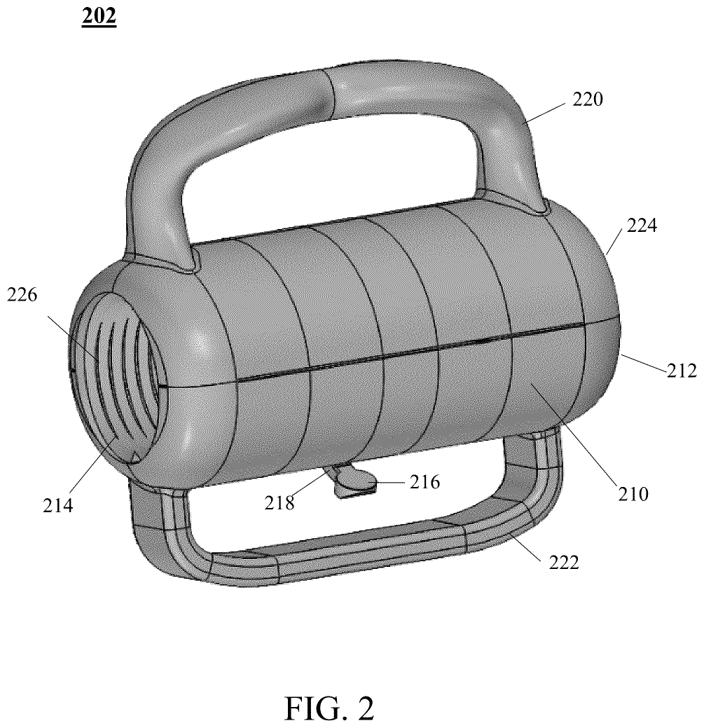

FIG. 2 is a diagram of a system of a wildfire protection system according to an embodiment of the present disclosure. FIG. 2 depicts components and interactions of a system 202. Components provided by the system 202 are indexed to components of the system 100. The system 202 corresponds to the misting head 102a-n of system 100.

The misting head 202 comprises a casing 210 or main body of the misting head 202, an intake end 212, a discharge end 214, and a misting platform 216. The misting head 202 also comprises a misting arm 218, a loop 220, a platform guard 222, a first internal threading 224, and a second internal threading 226.

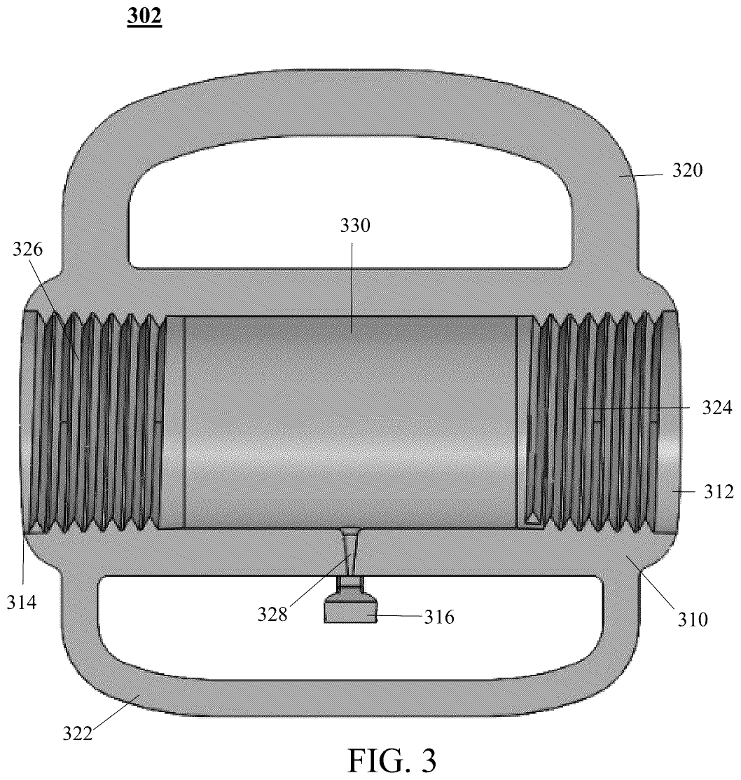

While not visible in FIG. 2, the casing 210 is hollow with a chamber that fills with water or other liquid. The casing 210 also has a funnel-like aperture or opening through a bottom portion of its body through which water under pressure is forced downward and out and toward the misting platform 216. The hollowness of the casing 210 and the funnel-like opening will be visible in FIG. 3, discussed below.

The intake end 212 is the opening in the casing 210 through which water is received from the hose section leading into the casing 210. The discharge end 214 is the opening through which water is discharged into the section leading out of and away from the casing and on to the next misting head 202 in the chain.

While FIG. 2 illustrates the intake end 212 on the right side of the misting head 202 and illustrates the discharge end 214 on the left side of the misting head 202, this illustration is based on water moving in a right to left direction at the misting head 202. As discussed above, a structure provided is wherein water enters the chain from both directions. It is therefore entirely feasible that the positions of the intake end 212 and the discharge end 214 may be reversed should water alternatively move in a left to right direction. The positions therefore of the intake end 212 and the discharge end 214 in FIG. 2 are for discussion purposes.

The misting platform 216 is directly below the funnel-like opening (not shown in FIG. 2). Water is forced out of the opening in a downward direction in a stream and strikes the surface of the misting platform 216. The misting platform 216 is nearly horizontal but is angled downward slightly and may be shaped in a concave or slightly spoon-shaped structure.

Because of this slight spoon-like concavity, when the water forced downward from the opening under pressure makes contact with the misting platform 216, the water radiates outward in a mist. This action takes place with a plurality of misting heads 202 in succession such that the mist falling from many misting heads 202 in a line can effectively form the misting curtain described above.

A party seeking to understand the misting platform 216 may consider a faucet in a kitchen sink for example. With water streaming out of the faucet in a downward fashion at a high pressure, a reader may hold a spoon (with the concave surface facing upward) into the water stream coming from the faucet. When the water makes contact with the concave surface of the spoon, the water radiates or fans outward. This is what occurs on a smaller scale with the misting platform 216.

The misting arm 218 holds the misting platform 216 in place. The misting arm 218 is not a tube and does not carry any water as water from the opening in the casing 210 is streamed directly downward to the misting platform 216 and makes little or no direct contact with the misting arm 218.

The loop 220 provides a means for the misting head 202 to be hung on a hook attached to an eave or rafter of a structure. The non-cylindrical shape of the diameter of the loop 220 is by design and is directed to the entire misting head 202 staying in place and not being moved about in the event of wind or slack in the chain, for example. The platform guard 222 serves a purpose of protecting the misting platform 216 and the misting arm 218 if these two components make contact with the ground or other surface and might otherwise break or be damaged.

The first internal threading 224 and the second internal threading 226 are threads in the internal cylindrical surfaces of the intake end 212 and the discharge end 214, respectively. In an embodiment, the hose sections 104a-n illustrated in FIG. 1 connect to the misting heads 102a-n via threading. The hose sections 104a-n may be externally threaded such that the hose sections 104a-n “screw into” the misting heads 102a-n. As with the intake end 212 and the discharge end 214 wherein their positions may be reversed as discussed above if water is alternatively moving in a left to right direction as opposed to a right to left direction, the positions of the first internal threading 224 and the second internal threading 226 would correspondingly be reversed as well when the water is moving from left to right.

The use of threading and screwing action to join the hose sections 104a-n with the misting heads 102a-n is merely one method of joining the many instances of these components in a chain. The present disclosure provides for other methods and technologies to be used to join the hose sections 104a-n with the misting heads 102a-n.

FIG. 3 is a diagram of a system of wildfire protection according to an embodiment of the present disclosure. A system 302 is provided herein and depicted in FIG. 3. Components of the system 302 are indexed to components of the system 202 and the system 100.

FIG. 3 is a front perspective cross-section view of the misting head 202 shown in greater detail in FIG. 2. A system 302 includes the components of the system 202 with most of them shown in FIG. 3.

Components shown in FIG. 3 that are not previously shown above are a funnel-like opening 328 and chamber 330. The funnel-like opening 328 is the aperture in the casing 310 through which water is forced downward and outward toward the misting platform 316. The chamber 330 is the internal area of the misting head 302 into which water enters via the intake end 312 and is then forced out either through the funnel-like opening 328 to the misting platform 316 or through the discharge end 314 and on to the next hose section and next misting head 302 in the chain.

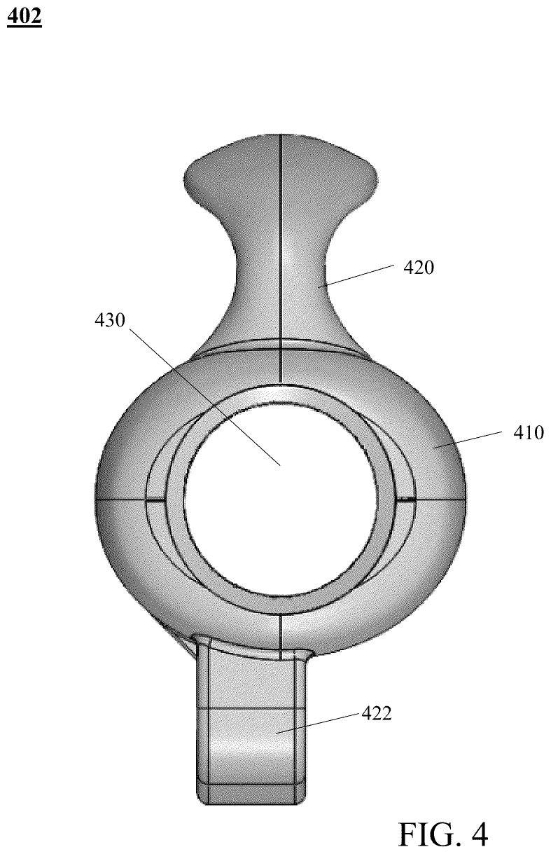

FIG. 4 is an end perspective cross-section view of a system of a misting head 402 provided herein. Components of the system 402 are indexed to the components of the system 100, the system 202, and the system 302 provided herein and discussed above. The misting head 402 shown in FIG. 4 comprises casing 410, loop 420, platform guard 422, and chamber 430. As noted briefly above, the loop 420 has a non-cylindrical diameter to better stabilize the entire chain, especially given the windy conditions the chain may be subjected to as well as the possibility that there may be slack in the chain.

The misting head 402 shown in FIG. 4 also comprises misting arm 418 and misting platform 416. As is particularly visible in FIG. 4 is the angled disposition of the misting platform 416 such that water sent downward through and out the funnel-like opening (not shown in FIG. 4) strikes the misting platform 416 and radiates outward.

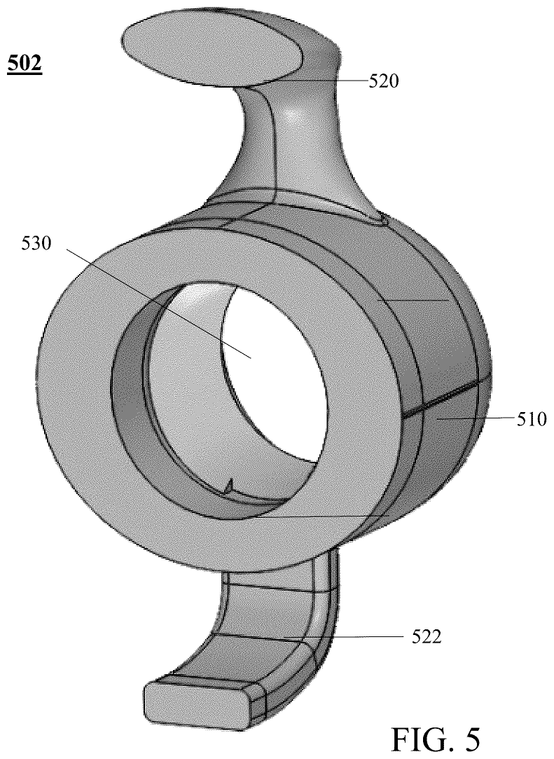

FIG. 5 is a diagram of a system of wildfire protection according to an embodiment of the present disclosure. FIG. 5 illustrates components and interactions of a system 502 of wildfire protection with components shown the same as those shown in FIG. 4 but with the system 502 depicted at an angle as opposed to “straight on” as in FIG. 4. Components of the system 502 are indexed to the components of the system 100, the system 202, the system 302, and the system 402 provided herein and discussed above. The elliptical or oval cross section shape of the loop 520 is prominent in FIG. 5, which as noted above is conducive to holding the misting head 502 in place, especially during periods of wind or when there is slack in the chain.

While the description of components and interactions above has been directed to protecting structures such as homes, systems and methods may be used to protect other elevated structures such as tents. Also, personnel, land, livestock and crops may be protected by the system. Further, the source of water need not be a faucet providing water from a municipal water source and may instead be a private water source such as a tank or spring or natural body of water. The chain need not be hung horizontally and may in embodiments be suspended vertically or in another manner. The components provided herein may be at least one of fireproof and fire-resistant.

In embodiments, the liquid used may not be water and instead is another liquid. While in most embodiments described above wherein the source of water is a faucet, additional devices to move water into and through the chain are not necessary. When the water source is a private such as a tank, or a natural source, such as a spring, devices may be needed to generate pressure to move the water. Otherwise, the actions of the misting heads 102a-n and the hose sections 104a-n are the same.

The system 100 need not be suspended from any object at all and may instead be laid flat on a roof surface, a ground surface, or some other surface. The system 100 may not be hung as described above but instead be attached to a vertical surface such as a wall. If the system 100 is to be attached to a structure, the structure need not be permanent, and may be temporary, for example a tent or temporary building that is dismantled when an event or other need for the temporary structure ends.

In an embodiment, a wildfire protection system is provided comprising a plurality of hose sections arranged in an end-to-end manner in a chain, each section about one foot in length. The system also comprises a plurality of misting heads about 2.5 inches in length each, one each of the plurality of heads positioned between ends of adjacent hose sections. Each misting head receives water at an intake end from a first connecting hose section, expels a portion of the water through at least one opening in each head, and releases a remainder of the received water at a discharge end to a second connecting hose section.

The chain receives water at one end and a second end is capped in a half circuit structure. Alternatively, the chain receives water at both ends in a closed loop structure, the structure at least directed to evenly distributing water pressure in the chain.

Under the alternative structure the two ends of the chain are one of connected to separate water sources and to a single water source that in selected instances involves the use of a “Y” splitter fitting coupled to a faucet. The system is suspended horizontally from at least one of an eave area, a roof area, a gutter area, and rafter of a structure.

The water expelled through the at least one opening per misting head along the plurality of misting heads contacts a misting platform below the head, causing the expelled water to radiate outward and create a mist curtain falling from the system.

The mist curtain is directed to preventing airborne embers from entering openings of the structure and from contacting other real and personal property. One of the first end of the system and both ends of the system draw water from at least one of a municipal source, a privately provided source, and a natural water source.

In another embodiment, a method of reducing risk of wildfire damage is provided comprising a horizontally positioned chain comprising a plurality of hose sections and a plurality of misting heads connected in an alternating manner receiving water under pressure at a first end of the chain. The method also comprises the chain passing water from the first end of the chain to a capped termination point at a second end of the chain. The method also comprises the chain expelling water through openings in the misting heads to misting platforms below, mist created from successive misting heads and misting platforms blending together and falling as a curtain from the horizontal chain.

The method also comprises the chain alternatively receiving water at both ends in a closed loop structure, the alternative structure at least directed to evenly distributing water pressure in the chain. Under the alternative step, the two ends of the chain are one of connected to separate water sources and connected to a single water source that in selected instances involves the use of a “Y” splitter fitting coupled to a faucet.

The method also comprises the misting heads receiving water at an intake end and discharging non-expelled water at a discharge end. The method also comprises the chain suspending horizontally from at least one of an eave area, a roof area, a gutter area, and rafter of a structure. The hose sections and the misting heads are at least one of fire resistant and fireproof.

In yet another embodiment, a system for protecting assets from damage caused by windblown wildfire debris is provided. The system comprises a water source, a connection hardware attached to the water source, and a chain of alternating hose sections and misting heads that connects at a first end of the chain to the connection hardware. The system also receives water from the water faucet via the connection hardware at the first end, wherein a second end of the chain is capped, passes water through the chain, and expels portions of the water downward through openings in the misting heads, the expelled water contacting misting platforms to form mist.

The chain alternatively receives water at both ends in a closed loop structure, the alternative structure at least directed to evenly distributing water pressure in the chain. Under the alternative step, the two ends of the chain are one of connected to separate water sources and connected to a single water source that in selected instances involves the use of a “Y” splitter fitting coupled to a faucet.

The misting heads receive water at an intake end and discharging non-expelled water at a discharge end. A horizontal manner of suspension facilitates the mist to fall from the chain in a curtain manner and is directed to preventing airborne embers from contacting at least one of the structure and personal property.

1. A wildfire protection system, comprising:
a plurality of hose sections arranged in an end-to-end manner in a chain, each section about one foot in length; and
a plurality of misting heads about 2.5 inches in length each, one each of the plurality of heads positioned between ends of adjacent hose sections, wherein each misting head:
receives water at an intake end from a first connecting hose section,
expels a portion of the water through at least one opening in each head, and
releases a remainder of the received water at a discharge end to a second connecting hose section.

2. The system of claim 1, wherein the chain receives water at one end and a second end is capped in a half circuit structure.

3. The system of claim 2, wherein alternatively the chain receives water at both ends in a closed loop structure, the structure at least directed to evenly distributing water pressure in the chain.

4. The system of claim 3, wherein under the alternative structure the two ends of the chain are one of connected to separate water sources and to a single water source that in selected instances involves the use of a “Y” splitter fitting coupled to a faucet.

5. The system of claim 1, wherein the system is suspended horizontally from at least one of an eave area, a roof area, a gutter area, and rafter of a structure.

6. The system of claim 1, wherein the water expelled through the at least one opening per misting head along the plurality of misting heads contacts a misting platform below the head, causing the expelled water to radiate outward and create a mist curtain falling from the system.

7. The system of claim 6, wherein the mist curtain is directed to preventing airborne embers from entering openings of the structure and from contacting other real and personal property.

8. The system of claim 3, wherein one of the first end of the system and both ends of the system draw water from at least one of a municipal source, a privately provided source, and a natural water source.

9. A method of reducing risk of wildfire damage, comprising:
a horizontally positioned chain comprising a plurality of hose sections and a plurality of misting heads connected in an alternating manner receiving water under pressure at a first end of the chain;
the chain passing water from the first end of the chain to a capped termination point at a second end of the chain; and
the chain expelling water through openings in the misting heads to misting platforms below, mist created from successive misting heads and misting platforms blending together and falling as a curtain from the horizontal chain.

10. The method of claim 9, further comprising the chain alternatively receiving water at both ends in a closed loop structure, the alternative structure at least directed to evenly distributing water pressure in the chain.

11. The method of claim 10, wherein under the alternative step, the two ends of the chain are one of connected to separate water sources and connected to a single water source that in selected instances involves the use of a “Y” splitter fitting coupled to a faucet.

12. The method of claim 9, further comprising the misting heads receiving water at an intake end and discharging non-expelled water at a discharge end.

13. The method of claim 12, further comprising the chain suspending horizontally from at least one of an eave area, a roof area, a gutter area, and rafter of a structure.

14. The method of claim 9, wherein the hose sections and the misting heads are at least one of fire resistant and fireproof.

15. A system for protecting assets from damage caused by windblown wildfire debris, comprising
a water source;
a connection hardware attached to the water source; and
a chain of alternating hose sections and misting heads that:
connects at a first end of the chain to the connection hardware,
receives water from the water faucet via the connection hardware at the first end, wherein a second end of the chain is capped,
passes water through the chain, and
expels portions of the water downward through openings in the misting heads, the expelled water contacting misting platforms to form mist.

16. The system of claim 15, wherein the chain alternatively receives water at both ends in a closed loop structure, the alternative structure at least directed to evenly distributing water pressure in the chain.

17. The system of claim 16, wherein under the alternative step, the two ends of the chain are one of connected to separate water sources and connected to a single water source that in selected instances involves the use of a “Y” splitter fitting coupled to a faucet.

18. The system of claim 15, wherein the misting heads receiving water at an intake end and discharging non-expelled water at a discharge end.

19. The system of claim 15, wherein the chain suspends horizontally from at least one of an eave area, a roof area, a gutter area, and rafter of a structure.

20. The system of claim 19, wherein the horizontal manner of suspension facilitates the mist to fall from the chain in a curtain manner and is directed to preventing airborne embers from contacting at least one of the structure and personal property.
